(19) United States
(12) Patent Application Publication
(10) Pub. No.: US 2002/0135613 A1
(43) Pub. Date: Sep. 26, 2002

(54) Transfer of personal information between computing systems

(76) Inventor: Sean M. O'Hara, Lebanon, OR (US)

Correspondence Address: HEWLETT-PACKARD COMPANY, Intellectual Property Administration, P.O. Box 272400, Fort Collins, CO, 80527-2400, US

(21) Appl. No.: 09/814,327

(22) Filed: Mar. 21, 2001

(51) Int. Cl. G06F 13/00

(52) U.S. Cl. 345/745; 345/741

(57) ABSTRACT

A personalized user environment on a computing system is provided. Upon detection of user-supplied storage media, a profile configuration program is run. The profile configuration program obtains profile information stored on the user-supplied storage media and temporarily installs the profile information on the computing system. The particular items are configured automatically based on information within the user-supplied storage media, or alternatively, may be tailored in response to particular instructions from a user indicating which items the user wants configured on the computing system. For additional protection, a password can be obtained from the user and verified before configuring the computing system.

### BACKGROUND

The present invention concerns interfacing with computing systems and pertains particularly to the transfer of personal information between computing systems.

Ownership of personal computers has revolutionized the way people perform their personal and business activities. There is a wide variety of available application software. Many operating system and application software packages can be personalized in accordance with the convenience and whim of the user.

For example, a user can personalize software to include his or her name, address, passwords for various internet sites, credit card numbers, program interface preferences, website links, digital badges, additional personal desktop configuration information and so on. This personalization information is stored in one or more profile/preference files on the user's computing system. This information, referred collectively herein as a user profile, greatly increases a user's ability to comfortably and conveniently perform tasks on his or her computing system.

When using a single computer over a long period of time, the amount of information within a user profile can be significant. This user profile can significantly enhance user efficiency. However, if a user is required to use a new computer, use multiple computers, or to share computer use with others, the user profile may not be immediately available.

One way for a user to overcome the problem of not having profile information on a new computer is to painstakingly reenter this information every time a new computer is utilized. A disk or other portable storage media can also be used to transport profile information from one computer to another. However, inevitably there is a significant amount of installation that must be performed for individual programs.

### SUMMARY OF THE INVENTION

In accordance with the preferred embodiment of the present invention, a personalized user environment on a computing system is provided. Upon detection of user-supplied storage media, a profile configuration program is run. The profile configuration program obtains profile information stored on the user-supplied storage media and temporarily installs the profile information on the computing system.

The particular items are configured automatically based on information within the user-supplied storage media, or alternatively, may be tailored in response to particular instructions from a user indicating which items the user wants configured on the computing system. For additional protection, a password can be obtained from the user and verified before configuring the computing system.

For example, the profile information is installed on a random access memory (RAM) drive within memory of the computing system. Alternatively, the profile information is temporarily stored on a hard drive within the computing system.

In the preferred embodiment of the present invention, user interactions that result in changes to the profile information are detected. The changes are used to update the profile information stored on the storage media. For example, the updates to profile information on the storage media are performed during a user session on the computing system as the changes occur. Alternatively, the updates to profile information on the storage media are performed after completion of a user session on the computing system.

The present invention provides for convenient configuration of the computing environment for the user of a computing system. It is convenient to the user and does not require any arcane system knowledge. A user can carry the profile information in a convenient and secure form. For example, the information cn be carried in the form of a simple card that can be transported in a wallet or purse. This allows a user to use a computer/kiosk type device at any business, hotel, conference facility, airport, etc in the world and have the ability to make that computing system provide a user environment familiar to and convenient for the user.

### BRIEF DESCRIPTION OF THE DRAWINGS

FIG. 1 shows a computing system with a smart card reader.

FIG. 2 shows a computer keyboard with a magnetic card reader.

FIG. 3 is a flowchart that illustrates automated entry of a personal profile into a computing system in accordance with a preferred embodiment of the present invention.

FIG. 4 is a flowchart that illustrates automated retrieval of changes to a personal profile from a computing system in accordance with a preferred embodiment of the present invention.

### DESCRIPTION OF THE PREFERRED EMBODIMENT

The present invention allows user profile information such as website links, digital badges, passwords, other personal desktop configuration information to be automatically configured from storage media such as a “smart” card or magnetic strip card.

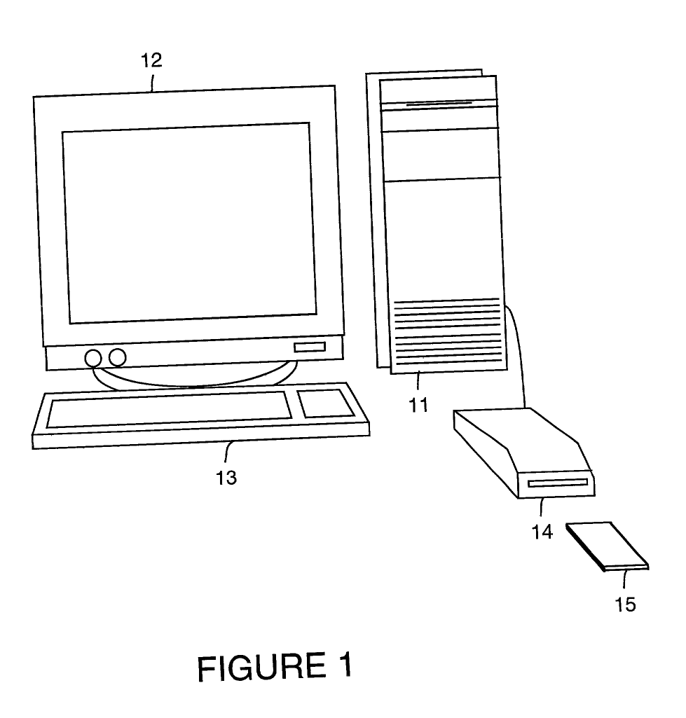

A computing system 11 shown in FIG. 1, includes, in addition to a display 12 and a keyboard 13, a media reader/writer 14. Media reader/writer 14 allows user profile information to be conveniently transported between computing systems.

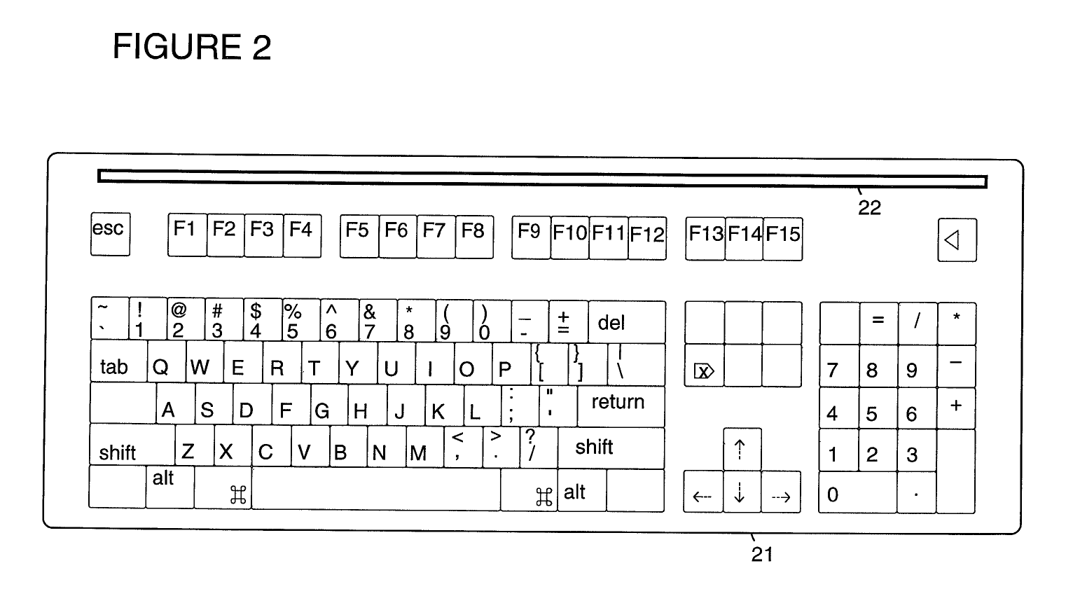

For example, media reader/writer 14 is a SmartMedia reader/writer available from Scan Logic Corporation, having a business address of 8 New England Executive Park, Burlington, Mass. 01803. Alternatively, media reader/writer 14 is a compact flash card reader/writer, a floppy disk drive, a Zip drive, or any reader/writer capable of accessing data from some type of data portable storage media. Alternative to media reader 14, keyboard 13 can include a magnetic strip reader 22, as shown in FIG. 2. Other read/writer systems, for example infrared (IR) input/output (I/O) devices, can be also be used instead of media reader/writer 14. This could allow certain user-controlled information to be transferred conveniently between portable storage media, or to, for example, an IR-enabled personal digital assistant (PDA) not having a card writer/reader.

Computing system 11 acquires user profile information from a user-supplied portable storage media 15, such as a card. This profile information is not stored on computing system 11, but in portable storage media 15 carried by the user. Media reader/writer 14 is used to install the profile information temporarily on computing system 11. For increased security, data on portable storage media 15 is encrypted. A password or other key is requested of a user to authenticate the user and to decrypt the personal information.

Installed on computing system 11 is a computer program that contains the logic and control code to access and store appropriate personal information on portable storage media 15. The computer program is automatically invoked when portable storage media 15 is inserted in media reader/writer 14.

The user profile information stored within portable storage media 15 can contain configuration information that is used in the automatic configuration of the user environment on computing system 11. The user includes, for example, the appearance and style of desktop icons, background, menu bars, and so on. Allowing automatic personalization of the user environment increases user comfort and efficiency when working on a new computing system. Additionally, user profile information automatically installed on computing system 11 can also include, for example, user name, address, passwords for various internet sites, credit card numbers, program interface preferences, website links, digital badges, additional personal desktop configuration information, language choices, and so on.

In a preferred embodiment, the profile information on portable storage media 15 is updated every time the user makes a change to the user environment or makes other profile related changes while using computing system 11. For example, a change could be, for example, a new or changed password, an added favorite web link, and so on. This changed information is downloaded by computing system 11 back onto portable storage media 15. Thus, the information on portable storage media 15 is always kept current to the user's latest activity.

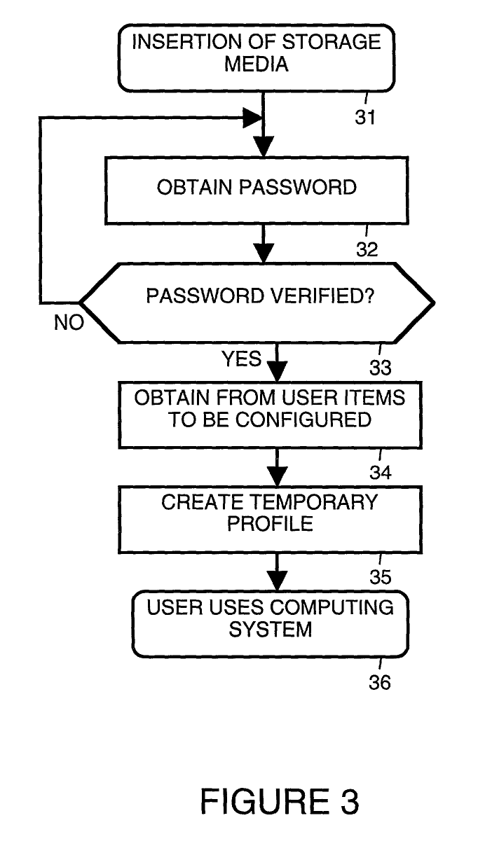

FIG. 3 is a flowchart that illustrates entry of a personal profile into computing system 11. The logic is performed by a computer program that interfaces with the operating system of computing system 11, (e.g., Mac X, OS/2, Windows, Linux)

In a step 31, portable storage media 15 is inserted in media reader/writer 14. In a step 32, the computer program prompts the user for a password. Upon obtaining a password, in a step 33, the computer program attempts to verify the password. If the password is not verified, step 32 is repeated. If the password is verified, in a step 34, the computer program requests from the user what items the user wants configured on computing system 11 to match profile information stored in portable storage media 15. For example, the user can indicate that bookmarks within a web browser are to configured. Alternatively, or in addition, the user can indicate that particular applications are to be configured, and/or that the desktop appearance is to be configured and so on. In an alternative embodiment of the present invention, step 34 is skipped and the computer program automatically determines what profile information is applicable to configuring computing system 11, and makes all the configurations without additional user interaction.

In a step 35, the computer program creates a temporary profile on computing system 11 from the applicable configuration information on portable storage media 15. For example, the temporary profile is created within a random access memory (RAM) drive memory allocated for use by the user. Alternatively, the temporary profile is created by writing the information to the hard drive for computing system 11. In this case the computer program tracks which changes are made to allow for recovery to the prior state. In any event, the result is that computing system 11 is configured in accordance with the profile information stored in portable storage media resulting in the user (when using computing system 11 in a step 36) experiencing a familiar user environment, even though this may be the first time the user uses computing system 11.

In addition to setting up a familiar user environment on computing system 11, the preferred embodiment of the present invention also provides for the automatic updating of the profile information on portable storage media 15, or alternatively, to an intranet/internet account. This allows for the user to save new bookmarks, digital badges, tweaks to the desktops or applications, and so on to be available to the user when the user next uses a computing system, regardless of which computing system is used, provided the computing system accepts profile information from portable storage media 15.

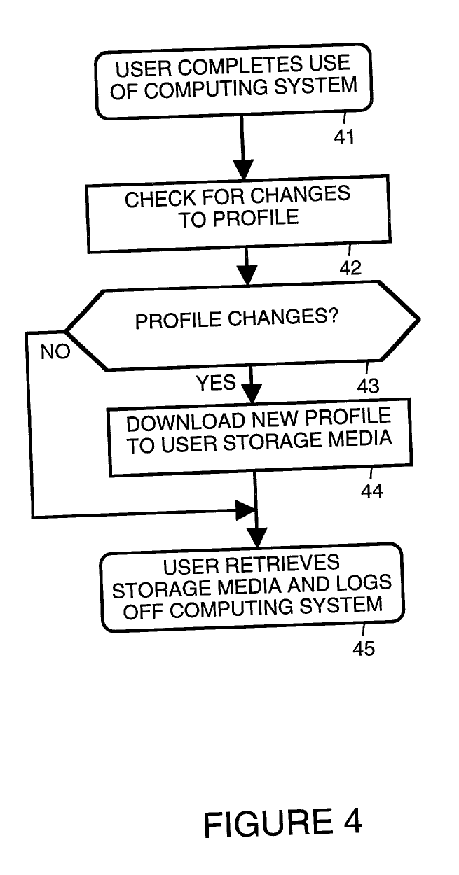

For example, FIG. 4 is a flowchart that illustrates retrieval of changes from computing system 11 to the personal profile stored within portable storage media 15. In a step 41, the user completes use of computing system 11. In a step 42, the computer program checks for changes made to profile information during the session. From a step 43, if there are profile changes, in a step 44, the new profile information is downloaded from computing system 11 to portable storage media 15. In a step 45, the user retrieves portable storage media 15 and logs of computing system 11. Alternatively, profile changes can be detected and downloaded to portable storage media 15 in real time as the user makes the changes on computing system 11.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

I claim:

1. A method for providing a personalized user environment on a computing system, the method comprising the following step:
(a) upon detection of user-supplied storage media, running a profile configuration program, the profile configuration program performing the following substeps:
(a.1) obtaining profile information stored on the user-supplied storage media, and
(a.2) temporarily installing the profile information on the computing system.

2. A method as in claim 1 wherein substep (a.1) includes the following substep:
requesting from a user an indication as to what items the user wants configured on the computing system.

3. A method as in claim 1 wherein in step (a) the following step is performed before performing substep (a.1):
obtaining a password from the user; and,
verifying the password.

4. A method as in claim 1 wherein substep (a.2) includes the following substep:
installing the profile information on a random access memory (RAM) drive within memory of the computing system.

5. A method as in claim 1 wherein substep (a.2) includes the following substep:
temporarily installing the profile information on a hard drive within the computing system.

6. A method as in claim 1 wherein step (a) additionally comprises the following substeps:
(a.3) detecting user interactions that result in changes to the profile information temporarily installed on the computing system in substep (a.2); and,
(a.4) using the changes to update the profile information stored on the storage media.

7. A method as in claim 6 wherein substep (a.4) is performed during a user session on the computing system as the changes occur.

8. A method as in claim 6 wherein substep (a.4) is performed after completion of a user session on the computing system.

9. A method for providing a personalized user environment on a computing system, the method performed by a profile configuration program, the method comprising the following step:
(a) obtaining profile information stored on user-supplied storage media; and,
(b) temporarily installing the profile information on the computing system.

10. A method as in claim 9 wherein step (a) includes the following substep:
requesting from a user an indication as to what items the user wants configured on the computing system.

11. A method as in claim 9 additionally comprising the following step performed before step (a):
obtaining a password from the user; and,
verifying the password.

12. A method as in claim 9 wherein step (b) includes the following substep:
installing the profile information on a random access memory (RAM) drive within memory of the computing system.

13. A method as in claim 9 wherein step (b) includes the following substep:
temporarily installing the profile information on a hard drive within the computing system.

14. A method as in claim 9 additionally comprising the following steps:
(c) detecting user interactions that result in changes to the profile information temporarily installed on the computing system in step (b); and,
(d) using the changes to update the profile information stored on the storage media.

15. A method as in claim 14 wherein step (b) is performed during a user session on the computing system as the changes occur.

16. A method as in claim 14 wherein step (b) is performed after completion of a user session on the computing system.

17. A computing system comprising:
a storage media reader and writer; and,
a profile configuration program for providing a personalized user environment on the computing system, wherein upon detection of user-supplied storage media being read by the storage media reader and writer, the profile configuration program obtains profile information stored on the user-supplied storage media, and temporarily installs the profile information on the computing system.

18. A computing system as in claim 17 wherein the profile configuration program installs the profile information on a random access memory (RAM) drive within memory of the computing system.

19. A computing system as in claim 17 wherein the profile configuration program temporarily installs the profile information on a hard drive within the computing system.

20. A computing system as in claim 17 wherein profile configuration program also detects user interactions that result in changes to the profile information temporarily installed on the computing system and uses the changes to update the profile information stored on the storage media.
